(19) United States
(12) Patent Application Publication
(10) Pub. No.: US 2025/0372723 A1
(43) Pub. Date: Dec. 4, 2025

(54) ALL-SOLID-STATE BATTERY AND MANUFACTURING METHOD THEREFOR

(71) Applicant: SAMSUNG SDI CO., LTD., Yongin-si, Gyeonggi-do (KR)

(72) Inventors: Eungyeong LEE, Yongin-si, Gyeonggi-do (KR); Gunwook LEE, Yongin-si, Gyeonggi-do (KR); Jihyoung PARK, Yongin-si, Gyeonggi-do (KR); Young Gyoon RYU, Yongin-si, Gyeonggi-do (KR)

(21) Appl. No.: 18/875,920

(22) PCT Filed: Jul. 14, 2023
(86) PCT No.: PCT/KR2023/010102

§ 371 Date: Dec. 17, 2024

(30) Foreign Application Priority Data
Oct. 25, 2022 (KR) 10-2022-0138688

(51) Int. Cl. H01M 10/0585; H01M 4/02; H01M 10/0562

(52) U.S. Cl. CPC H01M 10/0585; H01M 10/0562; H01M 2004/021; H01M 2300/0068

(57) ABSTRACT

A manufacturing method for an all-solid-state battery according to an embodiment includes a first step of coating a solid electrolyte membrane on a release film, a second step of pressing the release film coated with the solid electrolyte membrane onto a first electrode plate, and a third step of removing the release film while the solid electrolyte membrane is pressed onto the first electrode plate and stacking a second electrode plate on the solid electrolyte membrane.

### TECHNICAL FIELD

The present disclosure relates to an all-solid-state battery and a manufacturing method therefor, and more particularly, to an all-solid-state battery and a manufacturing method therefor having improved cell performance with a solid electrolyte membrane that does not include a framework and having freedom in the size of the solid electrolyte membrane by introducing the solid electrolyte membrane during the assembly process.

### BACKGROUND ART

An all-solid-state battery includes a positive electrode plate, a solid electrolyte membrane, and a negative electrode plate. The solid electrolyte membrane is a medium that conducts lithium ions. In the case of a lithium precipitation-type solid-state battery, lithium ions moved from the positive electrode plate are precipitated and deposited as metal on the negative electrode plate, and lithium metal is precipitated on the negative electrode plate during charging, regardless of the presence or absence of active material on the negative electrode plate.

An all-solid-state battery with a precipitated negative electrode plate has no housing, and when charging, lithium ions moved from the positive electrode plate are precipitated from the negative electrode plate, and when discharging, lithium ions accumulated on the negative electrode plate are dissociated from the negative electrode plate and moved back to the positive electrode plate.

There are several process methods for introducing solid electrolyte membranes in all-solid-state batteries utilizing solid electrolytes. In general, there may be a method through a sintering or a casting method utilizing a liquid slurry mixed with a solid electrolyte and a binder.

The sintering method increases interfacial adhesion with an electrode composite and adhesion of the solid electrolyte membrane itself. The liquid casting method may be used to manufacture a self-supporting membrane using a framework such as a non-woven fabric.

However, the above method is almost impossible to apply to roll-to-roll coating due to the high porosity and weak mechanical strength of the framework, and since the non-woven fabric electrochemically corresponds to a resistor inside the battery, the non-woven fabric needs to be removed to increase energy density and reduce resistance inside the battery.

There is a method of directly coating a liquid solid electrolyte slurry onto the electrode plate. In this case, a roll-to-roll coating process is used, but if coating is performed directly on the plate, it is difficult to detect defects such as pinholes. The introduction of a solid electrolyte membrane without sintering may lead to battery failure if a process for detecting defects such as pinholes or impurities inside the solid electrolyte membrane is not performed.

### DISCLOSURE

### Technical Problem

An embodiment provides a manufacturing method for an all-solid-state battery having improved cell performance with a solid electrolyte membrane that does not include a framework and having freedom in the size of the solid electrolyte membrane by introducing the solid electrolyte membrane during the assembly process. In addition, an embodiment provides an all-solid-state battery manufactured by the manufacturing method for the all-solid-state battery.

### Technical Solution

A manufacturing method for an all-solid-state battery according to an embodiment includes a first step of coating a solid electrolyte membrane on a release film, a second step of pressing the release film coated with the solid electrolyte membrane onto a first electrode plate, and a third step of removing the release film while the solid electrolyte membrane is pressed onto the first electrode plate, and a fourth step of stacking a second electrode plate on the solid electrolyte membrane.

The second step may be to press the solid electrolyte membrane onto the positive electrode plate, which is the first electrode plate, the third step may be to remove the release film from the solid electrolyte membrane, and the fourth step may be to stack a negative electrode plate, which is the second electrode plate, on the solid electrolyte membrane.

The second step may be to press the solid electrolyte membrane onto the negative electrode plate, which is the first electrode plate, the third step may be to remove the release film from the solid electrolyte membrane, and the fourth step may be to stack a positive electrode plate, which is the second electrode plate, on the solid electrolyte membrane.

The second step may be compressed by a hydraulic press using a stacker.

In the second step, when among the first electrode plate and the second electrode plate, the size of one negative electrode plate is larger than the size of the other positive electrode plate, and the size of the solid electrolyte membrane is larger than the size of the negative electrode plate, a gasket may be removed or applied.

In the second step, when applying the gasket, the size of the solid electrolyte membrane may be made larger than the internal size of the gasket.

In the second step, when among the first electrode plate and the second electrode plate, the size of one positive electrode plate is larger than or equal to the size of the other negative electrode plate, and the size of the solid electrolyte membrane is smaller than the size of the negative electrode plate, the gasket may be applied.

In the second step, the size of the solid electrolyte membrane may be made larger than or equal to the internal size of the gasket.

In the second step, when among the first electrode plate and the second electrode plate, the size of one positive electrode plate is larger than or equal to the size of the other negative electrode plate, and the size of the solid electrolyte membrane is larger than the size of the positive electrode plate, the gasket may be removed or applied.

In the second step, when applying the gasket, the size of the solid electrolyte membrane may be made larger than the internal size of the gasket.

In the second step, the use of expensive solid electrolyte materials may be reduced by adopting a solid electrolyte membrane smaller than the electrode plate even when the gasket is applied when the sizes of the electrode plate and the solid electrolyte membrane are the same and their alignment is mismatched.

In the first step, a release film including PET coated with one of silicon, PTFE, and polyethylene on at least one surface may be applied.

In the first step, a solid electrolyte slurry including a sulfide-based solid electrolyte, a polymer binder, a dispersant, and a solvent may be coated on the release film.

An all-solid-state battery according to an embodiment includes a first electrode plate, a solid electrolyte membrane pressed onto the first electrode plate as a first surface, and a second electrode plate stacked on a second surface of the solid electrolyte membrane, wherein the solid electrolyte membrane includes a sulfide-based solid electrolyte, a binder, and a dispersant.

The first electrode plate may be a positive electrode plate, the solid electrolyte membrane may be pressed onto the positive electrode plate as the first surface, the second electrode plate may be a negative electrode plate, and the negative electrode plate may be stacked on the second surface of the solid electrolyte membrane.

The first electrode plate may be a negative electrode plate, the solid electrolyte membrane may be pressed onto the negative electrode plate as the first surface, the second electrode plate may be a positive electrode plate, and the positive electrode plate may be stacked on the second surface of the solid electrolyte membrane.

Among the first electrode plate and the second electrode plate, the size of one negative electrode plate may be larger than the size of the other positive electrode plate, and the size of the solid electrolyte membrane may be larger than the size of the negative electrode plate.

An all-solid-state battery according to an embodiment may further include a gasket, wherein the size of the solid electrolyte membrane may be larger than the internal size of the gasket.

Among the first electrode plate and the second electrode plate, the size of one positive electrode plate may be larger than or equal to the size of the other negative electrode plate, and the size of the solid electrolyte membrane may be smaller than the size of the negative electrode plate, the gasket may be further included, and the size of the solid electrolyte membrane may be larger than or equal to the internal size of the gasket.

Among the first electrode plate and the second electrode plate, the size of one positive electrode plate may be larger than or equal to the size of the other negative electrode plate, and the size of the solid electrolyte membrane may be larger than the size of the positive electrode plate.

An all-solid-state battery according to an embodiment may further include the gasket, wherein the size of the solid electrolyte membrane may be larger than the internal size of the gasket.

### Advantageous Effect

In one embodiment, an all-solid-state battery is manufactured by coating a solid electrolyte membrane on a release film, pressing the release film onto a first electrode plate, removing the release film while the solid electrolyte membrane is pressed onto the first electrode plate, and stacking a second electrode plate on the solid electrolyte membrane.

That is, an embodiment may have improved cell performance with a solid electrolyte membrane that does not include a framework, and may have freedom in the size of the solid electrolyte membrane by introducing the solid electrolyte membrane during the assembly process.

### DESCRIPTION OF THE DRAWINGS

FIG. 1A is a flow chart of a manufacturing method for an all-solid-state battery according to an embodiment of the present disclosure.

FIG. 1B is a process diagram of a manufacturing method for an all-solid-state battery according to an embodiment of the present disclosure.

FIG. 2 is an exploded perspective view of an all-solid-state battery according to a first embodiment of the present disclosure.

FIG. 3 is a cross-sectional view taken along line III-III of FIG. 2.

FIG. 4 is a cross-sectional view of an all-solid-state battery according to a second embodiment of the present disclosure.

FIG. 5 is a perspective view of an all-solid-state battery according to a third embodiment of the present disclosure.

FIG. 6 is a cross-sectional view taken along line VI-VI of FIG. 5.

FIG. 7 is a cross-sectional view of an all-solid-state battery according to a fourth embodiment of the present disclosure.

FIG. 8 is a perspective view of an all-solid-state battery according to a fifth embodiment of the present disclosure.

FIG. 9 is a cross-sectional view taken along line IX-IX of FIG. 8.

FIG. 10 is a cross-sectional view of an all-solid-state battery according to a sixth embodiment of the present disclosure.

FIG. 11 is a cross-sectional view of an all-solid-state battery according to a seventh embodiment of the present disclosure.

### MODE FOR INVENTION

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present invention. The drawings and description are to be regarded as illustrative and not restrictive in nature, and like reference numerals designate like elements throughout the specification.

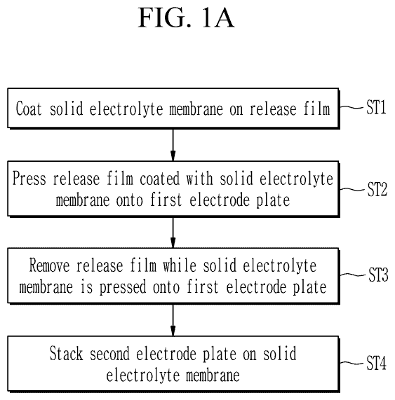

FIG. 1A is a flow chart of a manufacturing method for an all-solid-state battery according to an embodiment of the present disclosure, and FIG. 1B is a process diagram of a manufacturing method for an all-solid-state battery according to an embodiment of the present disclosure. Referring to FIGS. 1A and 1B, the manufacturing method for the all-solid-state battery includes a first step ST1, a second step ST2, a third step ST3, and a fourth step ST4.

In the first step ST1, a solid electrolyte membrane SE is coated on a release film F. In the second step ST2, the release film F coated with the solid electrolyte membrane SE is pressed onto a first electrode plate E1.

In the third step ST3, the release film F is removed while the solid electrolyte membrane SE is pressed onto the first electrode plate E1. In the fourth step ST4, a second electrode plate E2 is stacked on the solid electrolyte membrane SE.

In the first step ST1, a liquid solid electrolyte slurry is manufactured by coating it on the release film F and drying it.

The release film F coated with a solid electrolyte membrane (SE) is notch-punched and standardized to the required size.

The release film F is formed of polyethylene terephthalate (PET). For example, the release film F may be formed of PET coated on at least one surface with one of silicon, polytetrafluoroethylene (PTFE), and polyethylene.

The solid electrolyte slurry includes a sulfide-based solid electrolyte, a binder, a dispersant, and a solvent. For example, polymeric binder materials include, but are not limited to, acrylates, rubbers, and butyrates. The dispersant may be hydrocarbon and other sulfide-based solid electrolytes, as well as any material that aids dispersion in the slurry. The solvent is a solvent with low polarity, preferably isobutyl isobutyrate, octyl acetate, and xylene.

In the first step ST1, before pressing of the solid electrolyte membrane SE, a film portion of the solid electrolyte membrane SE coated on the release film F may be easily detected for defects in the solid electrolyte membrane SE through LED vision inside a battery assembly stacker.

In the second step ST2, the release film F coated with the solid electrolyte membrane SE may be bonded to the first electrode plate E1 using a hydraulic press P by a stacker. The hydraulic press P may remove the gasket or protective tape to solve the problem of short circuit inside the cell when the size of the solid electrolyte membrane SE is larger than that of the first and second electrode plates E1 and E2 depending on the cell structure of the all-solid-state battery. Therefore, the hydraulic press P may increase the cell energy density of all-solid-state batteries. The first and second plates E1 and E2 are separately notch-punched, then standardized to the required size.

In addition, in the second step ST2, if the first and second electrode plates E1 and E2 and the solid electrolyte membrane SE have the same size and are misaligned, a gasket is applied, thereby enabling the adoption of the solid electrolyte membrane SE smaller in size than the first and second electrode plates E1 and E2. Therefore, the hydraulic press P may reduce the use of expensive solid electrolyte membrane materials, thereby ensuring cost-effectiveness.

The solid electrolyte membrane SE having the same size as the first and second electrode plates E1 and E2 may be manufactured and attached using a hydraulic press during the all-solid-state battery assembly process, and then the release film F may be attached and removed for use.

The solid electrolyte membrane SE having different sizes from the first and second electrode plates E1 and E2 may also be applied. By creating a mold having different sizes from the first and second electrode plates E1 and E2 and pouring a solid electrolyte slurry into it, pinholes may be detected in a casting and semi-dry state, and one of the first and second electrode plates E1 and E2 may be introduced to integrate with the solid electrolyte membrane SE.

In the third step ST3, the release film F is removed while the solid electrolyte membrane SE is pressed onto the first electrode plate E1. That is, the solid electrolyte membrane SE is pressed onto one surface of the first electrode plate E1 in a self-supporting type without a framework.

In the second and third steps ST2 and ST3, the solid electrolyte membrane SE is formed into a self-supporting type, allowing the introduction of the solid electrolyte membrane SE with the unnecessary framework removed. The solid electrolyte membrane SE may solve the difficulty of detecting pinholes or cracks that may occur when a solid electrolyte membrane is introduced by directly coating it on a conventional electrode plate, and may improve the quality of the solid electrolyte membrane SE.

In the fourth step ST4, an all-solid-state battery is assembled by stacking the second electrode plate E2 on the solid electrolyte membrane SE.

Meanwhile, in the second step ST2, the solid electrolyte membrane SE is pressed onto the positive electrode plate, which is the first electrode plate E1, in the third step ST3, the release film F is removed from the solid electrolyte membrane SE, and in the fourth step ST4, the negative electrode plate, which is the second electrode plate E2, is stacked on the solid electrolyte membrane SE, thereby assembling an all-solid-state battery.

In addition, in the second step ST2, the solid electrolyte membrane SE is pressed onto the negative electrode plate, which is the first electrode plate E1, in the third step ST3, the release film F is removed from the solid electrolyte membrane SE, and in the fourth step ST4, the positive electrode plate, which is the second electrode plate E2, is stacked on the solid electrolyte membrane SE, thereby assembling an all-solid-state battery.

The following describes specific methods for each step of the manufacturing method for the all-solid-state battery through various embodiments.

The step-by-step configuration applied to each embodiment and the configuration of the all-solid-state battery formed thereby will be described in detail.

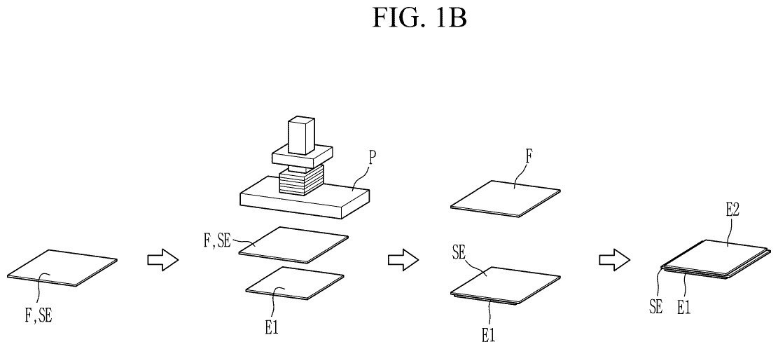

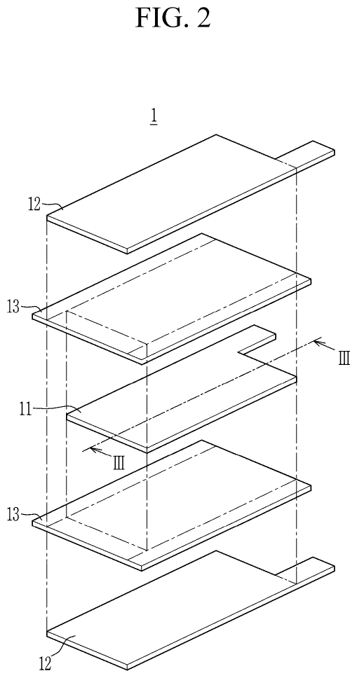

FIG. 2 is an exploded perspective view of an all-solid-state battery according to a first embodiment of the present disclosure, and FIG. 3 is a cross-sectional view taken along line III-III of FIG. 2. Referring to FIGS. 2 and 3, an all-solid-state battery 1 of the first embodiment is formed in such a way that among the first electrode plate E1 and the second electrode plate E2, the size of one negative electrode plate 12 is larger than the size of the other positive electrode plate 11, and the size of a solid electrolyte membrane 13 is larger than the size of the negative electrode plate 12.

The second step ST2 may not apply a gasket 14. That is, since the solid electrolyte membrane 13 of the all-solid-state battery 1 of the first embodiment has the largest size, internal short circuit may be prevented even without using a gasket. In this way, since the solid electrolyte membrane 13 is introduced during the assembly process, the all-solid-state battery 1 may have freedom with respect to the size of the solid electrolyte membrane 13.

The stacking structure of the positive electrode plate 11, the solid electrolyte layer 13, and the negative electrode plate 12 forms a unit cell. The unit cell may be formed as a mono-cell that charges and discharges on one side of the positive electrode plate 11 (not shown). As shown in FIG. 3, the unit cell may be formed as a bi-cell that charges and discharges on both sides of the positive electrode plate 11. The positive electrode plate 11 may have positive electrode active material layers 112 and 113 on both surfaces of a positive electrode current collector 111.

The all-solid-state battery 1 of the first embodiment includes the first electrode plate E1, the solid electrolyte membrane 13 pressed onto the first electrode plate E1 as a first surface, and the second electrode plate E2 stacked on a second surface of the solid electrolyte membrane 13. The solid electrolyte membrane 13 includes a sulfide-based solid electrolyte, a polymer binder, and a dispersant.

The all-solid-state battery 1 including the solid electrolyte membrane 13 without a framework improves ion conductivity in the solid electrolyte membrane 13, and improves discharge capacity, discharge rate characteristics, and cycle performance compared to a case having a framework.

On the other hand, the first electrode plate E1 is a positive electrode plate, the solid electrolyte membrane is pressed onto the positive electrode plate as the first surface, the second electrode plate E2 is a negative electrode plate, and the negative electrode plate is stacked on the second surface of the solid electrolyte membrane, so that the all-solid-state battery may be formed.

In addition, the first electrode plate E1 is a negative electrode plate, the solid electrolyte membrane is pressed onto the negative electrode plate as the first surface, the second electrode plate E2 is a positive electrode plate, and the positive electrode plate is stacked on the second surface of the solid electrolyte membrane, so that the all-solid-state battery may be formed.

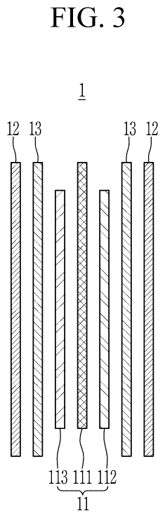

FIG. 4 is a cross-sectional view of an all-solid-state battery according to a second embodiment of the present disclosure. Referring to FIG. 4, an all-solid-state battery 2 of the second embodiment may apply the gasket 14 to prevent internal short circuit during the manufacturing process.

In the second step ST2, when applying the gasket 14, the size of the solid electrolyte membrane 13 is formed larger than the internal size of the gasket 14. In the second step ST2, the gasket 14 is provided on the outer side of the positive active material layers 112 and 113, thereby further preventing short circuit between the positive active material layers 112 and 113 and the negative electrode plate 12. At this time, the external size of the gasket 14 may be formed to be the same as the size of the solid electrolyte membrane 13. In this way, since the solid electrolyte membrane 13 is introduced and the gasket 14 is applied during the assembly process, the all-solid-state battery 2 may have more freedom with respect to the size of the solid electrolyte membrane 13.

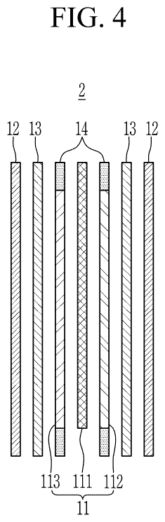

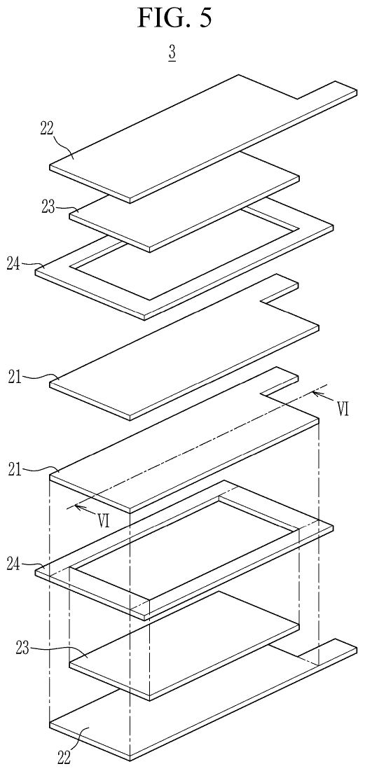

FIG. 5 is a perspective view of an all-solid-state battery according to a third embodiment of the present disclosure, and FIG. 6 is a cross-sectional view taken along line VI-VI of FIG. 5. Referring to FIGS. 5 and 6, an all-solid-state battery 3 of the second embodiment is formed in such a way that among the first electrode plate E1 and the second electrode plate E2, the size of one positive electrode plate 21 is larger than or equal to the size of the other negative electrode plate 22, and the size of a solid electrolyte membrane 23 is smaller than the size of the negative electrode plate 22.

The second step ST2 requires the application of a gasket 24. That is, since the all-solid-state battery 3 of the third embodiment has the smallest solid electrolyte membrane 23, the gasket 24 may be used to prevent internal short circuit. In this way, since the solid electrolyte membrane 23 is introduced during the assembly process, the gasket 24 may be applied even when the size of the solid electrolyte membrane 23 is small, so the all-solid-state battery 3 may have more freedom with respect to the size of the solid electrolyte membrane 23.

In the second step ST2, the size of the solid electrolyte membrane 23 is formed to be larger than or equal to the internal size of the gasket 24. In the second step ST2, the gasket 24 is provided on the outer side of the solid electrolyte membrane 23, thereby further preventing short circuit between the positive electrode plate 21 and the negative electrode plate 22. At this time, the external size of the gasket 24 may be formed to be the same as the size of the positive electrode plate 21.

The stacking structure of the positive electrode plate 21, the solid electrolyte layer 23, and the negative electrode plate 22 forms a unit cell. The unit cell is formed as a mono-cell that charges and discharges on one side of the positive electrode plate 21. The unit cell may be formed as a bi-cell that charges and discharges on both sides of the positive electrode plate.

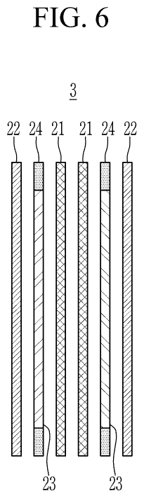

FIG. 7 is a cross-sectional view of an all-solid-state battery according to a fourth embodiment of the present disclosure. Referring to FIG. 7, a gasket 25 is applied to prevent internal short circuit during the manufacturing process of an all-solid-state battery 4 of the fourth embodiment.

In the second step ST2, the size of the solid electrolyte membrane 23 is formed to be larger than the internal size of the gasket 25. In the second step ST2, the gasket 25 is provided with a one-sided bending structure around the outer side of the solid electrolyte membrane 23, thereby more effectively preventing short circuits between the positive electrode plate 21 and the negative electrode plate 22. At this time, the external size of the gasket 25 may be formed to be the same as the size of the positive electrode plate 21.

In this way, since the solid electrolyte membrane 23 is introduced during the assembly process, the gasket 25 may be applied even when the size of the solid electrolyte membrane 23 is larger than the internal size of the gasket 25, so the all-solid-state battery 4 may have more freedom with respect to the size of the solid electrolyte membrane 23.

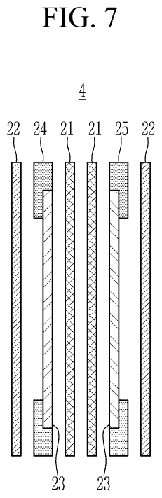

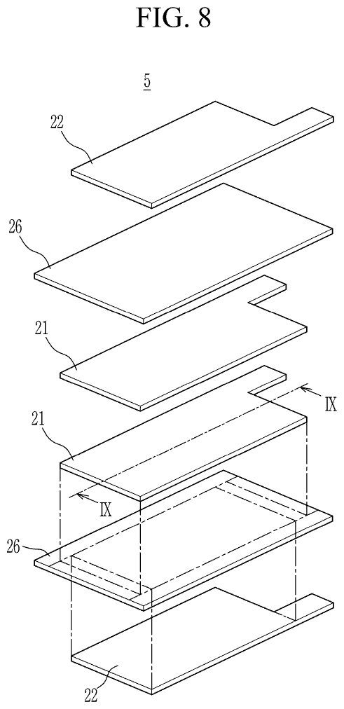

FIG. 8 is a perspective view of an all-solid-state battery according to a fifth embodiment of the present disclosure, and FIG. 9 is a cross-sectional view taken along line IX-IX of FIG. 8. Referring to FIGS. 8 and 9, an all-solid-state battery 5 of the fifth embodiment is formed in such a way that among the first electrode plate E1 and the second electrode plate E2, the size of one positive electrode plate 21 is larger than or equal to the size of the other negative electrode plate 22, and the size of a solid electrolyte membrane 26 is larger than the size of the positive electrode plate 21.

The second step ST2 may not apply a gasket. That is, in the all-solid-state battery 5 of the fifth embodiment, the size of the solid electrolyte membrane 26 is larger than the sizes of the positive electrode plate 21 and the negative electrode plate 22, so that an internal short circuit may be prevented without using a gasket.

In this way, since the solid electrolyte membrane 26 is introduced during the assembly process and the size of the solid electrolyte membrane 26 is larger than the size of the positive electrode plate 21, the all-solid-state battery 5 may have freedom with respect to the size of the solid electrolyte membrane 26.

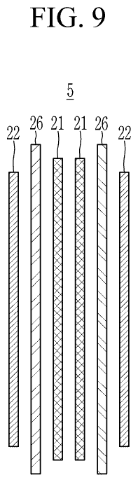

FIG. 10 is a cross-sectional view of an all-solid-state battery according to a sixth embodiment of the present disclosure. Referring to FIG. 10, an all-solid-state battery 6 of the sixth embodiment is formed in such a way that among the first electrode plate E1 and the second electrode plate E2, the size of one positive electrode plate 21 is equal to the size of the other negative electrode plate 32, and the size of the solid electrolyte membrane 26 is larger than the sizes of the positive electrode plate 21 and the negative electrode plate 32.

The second step ST2 may not apply a gasket. That is, in the all-solid-state battery 6 of the fifth embodiment, the size of the solid electrolyte membrane 26 is larger than the sizes of the positive electrode plate 21 and the negative electrode plate 32, so that an internal short circuit may be prevented without using a gasket.

In this way, since the solid electrolyte membrane 26 is introduced during the assembly process and the size of the solid electrolyte membrane 26 is larger than the sizes of the positive electrode plate 21 and the negative electrode plate 32, the all-solid-state battery 6 may have freedom with respect to the size of the solid electrolyte membrane 26.

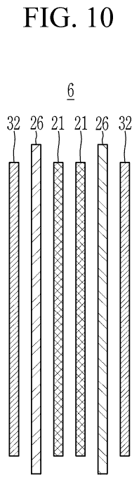

FIG. 11 is a cross-sectional view of an all-solid-state battery according to a seventh embodiment of the present disclosure. Referring to FIG. 11, an all-solid-state battery 7 of the seventh embodiment may apply a gasket 34 to prevent internal short circuit during the manufacturing process.

In the second step ST2, when applying the gasket 34, the size of a solid electrolyte membrane 36 is formed to be larger than the internal size of the gasket 34. At this time, the external size of the gasket 34 may be formed to be the same as the size of a positive electrode plate 41 and smaller than the size of the solid electrolyte membrane 36.

In this way, since the solid electrolyte membrane 36 is introduced during the assembly process, the size of the solid electrolyte membrane 36 is larger than the size of the positive electrode plate 41, and the gasket 34 is applied to the negative electrode plate 22, the all-solid-state battery 7 may have freedom with respect to the size of the solid electrolyte membrane 36.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

<Description of symbols>

| | |
|---|---|
| 1, 2, 3, 4: All-solid-state battery | 5, 6, 7: All-solid-state battery |
| 11, 21, 41: Positive electrode plate | 12, 22, 32: Negative |
| 13, 23, 26, 36: Solid electrolyte | electrode plate |
| membrane | 14, 24, 25, 34: Gasket |
| 111: Positive electrode current collector | 112, 113: Positive electrode |
| E1: First electrode plate | active material layer |
| F: Release film | E2: Second electrode plate |
| SE: Solid electrolyte membrane | P: Hydraulic press |

1. A manufacturing method for an all-solid-state battery, comprising:
a first step of coating a solid electrolyte membrane on a release film;
a second step of pressing the release film coated with the solid electrolyte membrane onto a first electrode plate;
a third step of removing the release film while the solid electrolyte membrane is pressed onto the first electrode plate; and
a fourth step of stacking a second electrode plate on the solid electrolyte membrane.

2. The manufacturing method for the all-solid-state battery as claimed in claim 1, wherein
the second step is to press the solid electrolyte membrane onto the positive electrode plate, which is the first electrode plate,
the third step is to remove the release film from the solid electrolyte membrane,
and the fourth step is to stack a negative electrode plate, which is the second electrode plate, on the solid electrolyte membrane.

3. The manufacturing method for the all-solid-state battery as claimed in claim 1, wherein
the second step is to press the solid electrolyte membrane onto the negative electrode plate, which is the first electrode plate,
the third step is to remove the release film from the solid electrolyte membrane,
and the fourth step is to stack a positive electrode plate, which is the second electrode plate, on the solid electrolyte membrane.

4. The manufacturing method for the all-solid-state battery as claimed in claim 1, wherein
the second step is to press using a hydraulic press by a stacker.

5. The manufacturing method for the all-solid-state battery as claimed in claim 4, wherein
in the second step, when among the first electrode plate and the second electrode plate, the size of one negative electrode plate is larger than the size of the other positive electrode plate, and the size of the solid electrolyte membrane is larger than the size of the negative electrode plate,
a gasket is removed or applied.

6. The manufacturing method for the all-solid-state battery as claimed in claim 5, wherein
in the second step,
when applying the gasket, the size of the solid electrolyte membrane is made larger than the internal size of the gasket.

7. The manufacturing method for the all-solid-state battery as claimed in claim 4, wherein
in the second step, when among the first electrode plate and the second electrode plate, the size of one positive electrode plate is larger than or equal to the size of the other negative electrode plate, and the size of the solid electrolyte membrane is smaller than the size of the negative electrode plate,
the gasket is applied.

8. The manufacturing method for the all-solid-state battery as claimed in claim 7, wherein
in the second step, the size of the solid electrolyte membrane is made larger than or equal to the internal size of the gasket.

9. The manufacturing method for the all-solid-state battery as claimed in claim 4, wherein
in the second step, when among the first electrode plate and the second electrode plate, the size of one positive electrode plate is larger than or equal to the size of the other negative electrode plate, and the size of the solid electrolyte membrane is larger than the size of the positive electrode plate,
the gasket is removed or applied.

10. The manufacturing method for the all-solid-state battery as claimed in claim 9, wherein
in the second step, when applying the gasket, the size of the solid electrolyte membrane is made larger than the internal size of the gasket.

11. The manufacturing method for the all-solid-state battery as claimed in claim 4, wherein
in the second step, the use of expensive solid electrolyte materials is reduced by adopting a solid electrolyte membrane smaller than the electrode plate even when the gasket is applied when the sizes of the electrode plate and the solid electrolyte membrane are the same and their alignment is mismatched.

12. The manufacturing method for the all-solid-state battery as claimed in claim 1, wherein
in the first step, a release film including PET coated with one of silicon, PTFE, and polyethylene on at least one surface is applied.

13. The manufacturing method for the all-solid-state battery as claimed in claim 1, wherein
in the first step, the release film is coated with a solid electrolyte slurry including a sulfide-based solid electrolyte, a polymer binder, a dispersant.

14. An all-solid-state battery, comprising:
a first electrode plate;
a solid electrolyte membrane pressed onto the first electrode plate as a first surface; and
a second electrode plate stacked on a second surface of the solid electrolyte membrane,
wherein the solid electrolyte membrane includes a sulfide-based solid electrolyte, a binder, and a dispersant.

15. The all-solid-state battery as claimed in claim 14, wherein
the first electrode plate is a positive electrode plate,
the solid electrolyte membrane is pressed onto the positive electrode plate as the first surface,
the second electrode plate is a negative electrode plate,
and the negative electrode plate is stacked on the second surface of the solid electrolyte membrane.

16. The all-solid-state battery as claimed in claim 14, wherein
the first electrode plate is a negative electrode plate,
the solid electrolyte membrane is pressed onto the negative electrode plate as the first surface,
the second electrode plate is a positive electrode plate,
and the positive electrode plate is stacked on the second surface of the solid electrolyte membrane.

17. The all-solid-state battery as claimed in claim 14, wherein
among the first electrode plate and the second electrode plate, the size of one negative electrode plate is larger than the size of the other positive electrode plate, and the size of the solid electrolyte membrane is larger than the size of the negative electrode plate.

18. The all-solid-state battery as claimed in claim 17, further comprising:
a gasket,
wherein the size of the solid electrolyte membrane is larger than the internal size of the gasket.

19. The all-solid-state battery as claimed in claim 14, wherein
among the first electrode plate and the second electrode plate, the size of one positive electrode plate is larger than or equal to the size of the other negative electrode plate, and the size of the solid electrolyte membrane is smaller than the size of the negative electrode plate,
the gasket is further included,
and the size of the solid electrolyte membrane is larger than or equal to the internal size of the gasket.

20. The all-solid-state battery as claimed in claim 14, wherein
among the first electrode plate and the second electrode plate, the size of one positive electrode plate is larger than or equal to the size of the other negative electrode plate, and the size of the solid electrolyte membrane is larger than the size of the positive electrode plate.

21. The all-solid-state battery as claimed in claim 20, further comprising:
the gasket,
wherein the size of the solid electrolyte membrane is larger than the internal size of the gasket.
